(19) United States
(12) Patent Application Publication
(10) Pub. No.: US 2012/0273524 A1
(43) Pub. Date: Nov. 1, 2012

(54) Sani Clean

(76) Inventors: Elimelech Leifer, Brooklyn, NY (US); Cheskel Goldenberg, Brooklyn, NY (US)

(21) Appl. No.: 13/426,055

(22) Filed: Mar. 21, 2012

Related U.S. Application Data
(60) Provisional application No. 61/465,558, filed on Mar. 21, 2011.

(51) Int. Cl. B67D 7/06

(52) U.S. Cl. 222/180

(57) ABSTRACT

The invention provides a disinfectant solution conveniently packaged in a compact wall mounted pump dispenser, enabling users to treat various surfaces with the disinfectant formula prior to making direct contact. The Sani Clean comprises a hypoallergenic disinfecting, antibacterial and antiviral solution formulated to kill germs and bacteria on contact.

### CLAIM OF PRIORITY

This patent application claims priority under 35 USC 119 (e) (1) from U.S. Provisional Patent Application Ser. No. 61/465,558 filed Mar. 21, 2011, of common inventorship herewith entitled, “Sani Clean.”

### FIELD OF THE INVENTION

The present invention pertains to the field of disinfectant cleansers, and more specifically to the field of portable and wall mounted disinfectant dispensing units.

### BACKGROUND OF THE INVENTION

The prior art has put forth several designs for disinfectants and dispensers. Among these are:

US Patent 2004/0253153 to Robert Carmen Barone describes a portable spray canister with an aerosol trigger. The canister contains a disinfectant spray. A key chain is attached to the canister to provide an optional means of carrying the dispenser.

US Patent 2002/0066756 to Janice Kinsman describes a multiple spray apparatus for portable use. The spray apparatus is designed to be lightweight for easy portability and use in public facilities. This invention is comprised of three canisters to hold different spray agents such as an antibacterial spray, a scented spray and cleaning spray.

U.S. Pat. No. 6,283,334 to Cleary E. Mahaffey and Richard P. Lewis describes a personal dispensing system which allows various viscous liquid cleansing or sanitizing products to be carried on one's body. This invention comprises a product container having a mounting clip which allows the product container to be carried upright or to be inverted for quicker dispensing of the liquid.

None of these prior art references describe the present invention.

### SUMMARY OF THE INVENTION

It is an object of the present invention to provide a convenient wall mounted disinfecting unit for public rest rooms and establishments.

### BRIEF DESCRIPTION OF THE DRAWINGS

FIG. 1 is a perspective view of the wall unit dispenser next to a commode in a bathroom facility.

FIG. 2 is a close up view of the wall unit dispenser showing the dispensing nozzle, an expandable cord, and a side door for filling the unit with a disinfectant solution. This side door has a lock on it.

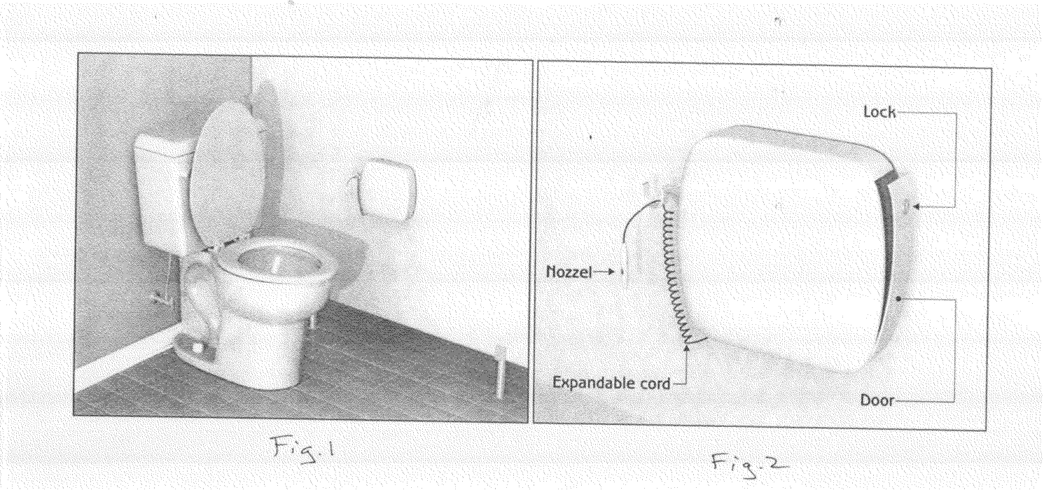

### DETAILED DESCRIPTION OF THE INVENTION

According to the Center for Disease Control, the basic steps to preventing these communicable diseases are easily followed. Obviously, the best way to prevent the spread of germs is by avoiding close personal contact with those who are feeling under the weather. As unpleasant as it may seem, being in close proximity when a cold or flu sufferer coughs or sneezes is a major way in which germs are spread from one person to the next. Another important tip for prevention is to wash hands frequently, especially after using the rest room, blowing the nose or rubbing eyes. Unfortunately, not everyone washes their hands on a regular basis, and public establishments such as shopping malls and airports can be a breeding ground for germs and bacteria that cause colds, flu and other communicable diseases.

Germs are commonly spread through the most basic of devices such as public telephones, escalator handrails, door knobs and public toilet seats. In particular, public toilet seats are rife with harmful agents.

According to a recent report filed by the AMA, American Medical Association, touching a toilet seat just once can leave enough germs and bacteria on the skin that hands must be washed five to six times consecutively, just to get rid of the majority of germs and bacteria. Thriving on hands, these germs and bacteria are also easily deposited onto the legs and buttocks. Realistically, few people have time or even consider showering five or six times after using the rest room. Most public toilet seats are a breeding ground for microscopic fecal coli form, a potentially deadly form of the E. Coli virus. The AMA reports that as many as twenty five percent of people leave the bathroom with traces of fecal coli form, usually E. Coli, on their bodies. It has been found that the common cold and influenza are easily transmitted from one person to the next via the public toilet. The problems associated with exposure to germs and bacteria are not limited to public toilets. The simple act of touching an escalator handrail or utilizing a public telephone can also expose one to these agents. A common scenario is when a busy young mother rushes into a public restroom to change her baby's diaper. After changing the soiled diaper, the woman rushes out of the restroom, forgetting to wash her hands. As the next user exits the restroom, they grab the door handle, unknowingly transferring minute traces of fecal matter, urine and bacteria left behind by the young mother, to their own freshly washed hands. Although extremely unsettling, such scenarios occur every day across the country.

The present invention, hereinafter referred to as the Sani Clean, is a unique product invention which offering consumers a sensible solution to the aforementioned challenges. The Sani Clean is a specially designed disinfectant solution conveniently packaged in a compact wall mounted pump dispenser, enabling users to treat various surfaces with the disinfectant formula prior to making direct contact. The Sani Clean comprises a hypoallergenic disinfecting, antibacterial and antiviral solution which formulated to kill germs and bacteria on contact. The Sani Clean formula is a quick drying solution and will dry completely within ten seconds of application to a designated surface. Manufactured of heavy duty plastic or aluminum material this dispenser is comprised of a rectangular shaped container for mounting on the wall near the commode, which serves as a receptacle for the disinfectant solution. Integrally attached to the proximal end of the Sani Clean is a small spray nozzle with the formula dispensed by a finger operated manual or aerosol pump. A cylindrical shaped cap is included for sale with the product and is used to cover the nozzle between uses. Emblazoned across the surface of the receptacle is the Sani Clean logo, and includes directions for use, an ingredient listing and any necessary precautionary warnings.

Use of the Sani Clean is very simple and straight forward. The user simply removes the fitted cap, aiming the dispenser nozzle directly at the surface area the user wishes to disinfect. The user depresses the unit nozzle and dispenses the solution over the surface area, killing germs and bacteria on contact. After use, the Sani Clean nozzle is covered until again needed. Another productive way to use Sani Clean is to insert it in an optional wall mounted housing unit in a bathroom facility next to commodes and diaper changing stations. This housing unit can be fabricated of plastic or stainless steel. Mounting brackets will be manufactured of a metal alloy. The dispensing hose and the spray nozzle will be fabricated of plastic.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device comprising a quick drying disinfectant solution that is inserted in a housing unit in public rest rooms and establishments, conveniently packaged in a compact wall mounted pump dispenser, enabling users to treat various surfaces with the disinfectant formula prior to making direct contact.

2. The device of claim 1 wherein the solution comprises a hypoallergenic disinfecting, antibacterial and antiviral solution which formulated to kill germs and bacteria on contact.

3. The device of claim 2 wherein the quick drying solution will dry completely within ten seconds of application to a designated surface.

4. The device of claim 1 wherein the housing is manufactured of heavy duty plastic or aluminum material, and wherein the dispenser is comprised of a rectangular shaped container for mounting on the wall near the commode, which serves as a receptacle for the disinfectant solution.

5. The device of claim 4, further comprising a small spray nozzle integrally attached to the proximal end of the housing wherein the solution is dispensed by a finger operated manual or aerosol pump.

6. The device of claim 5 further comprising a cylindrical shaped cap to cover the nozzle between uses, wherein the cap is integrally attached to the nozzle.
